(19) United States
(12) Patent Application Publication
(10) Pub. No.: US 2026/0039144 A1
(43) Pub. Date: Feb. 5, 2026

(54) ENHANCED COIL STRUCTURE FOR WIRELESS CHARGING

(71) Applicant: Meta Platforms Technologies, LLC, Menlo Park, CA (US)

(72) Inventors: Gordon Michael Coutts, Woodinville, WA (US); Lian Jie Zhao, Kent, WA (US); Vignesh Manohar, Toronto (CA); Lijun Zhang, Los Gatos, CA (US); Yauhen Radzikevich, Seattle, WA (US); Mehrbod Mohajer Jasebi, San Jose, CA (US)

(21) Appl. No.: 19/290,021

(22) Filed: Aug. 4, 2025

Related U.S. Application Data
(60) Provisional application No. 63/679,531, filed on Aug. 5, 2024.

(51) Int. Cl. H02J 50/00; H01F 27/28; H01F 41/04; H02J 50/10; H02J 50/90

(52) U.S. Cl. CPC H02J 50/005; H01F 27/2804; H01F 41/041; H02J 50/10; H02J 50/90; H01F 2027/2809

(57) ABSTRACT

An apparatus of the subject technology includes a first coil including a first plurality of turns of conductive traces and a second coil including a second plurality of turns of conductive traces and magnetically coupled to the first coil. At least one of the first coil or the second coil is fabricated by forming corresponding conductive traces on a substrate.

### CROSS REFERENCE TO RELATED APPLICATIONS

The present disclosure is related and claims priority under 35 USC § 119 (e) to U.S. Provisional Application No. 63/679,531, entitled “OPTIMIZED COIL AND DESIGN METHODOLOGY FOR WIRELESS CHARGING” filed on Aug. 5, 2024, the contents of which are herein incorporated by reference, in their entirety, for all purposes.

### TECHNICAL FIELD

The present disclosure generally relates to wireless charging, and more particularly, to an enhanced coil structure for wireless charging.

### BACKGROUND

Wireless power transfer (WPT) systems have become increasingly prevalent in consumer electronics, particularly for applications such as smartphones, wearables, and mixed reality (MR) devices such as augmented reality (AR) devices. These systems typically rely on inductive coupling between a transmit coil and a receive coil to deliver power without physical connectors. Conventional implementations often utilize wire-wound coils, which, while effective, present several limitations. The fixed geometry of wound coils restricts design flexibility, and the manual or semi-automated winding process can be labor-intensive and difficult to scale. Moreover, wound coils exhibit inefficiencies due to skin and proximity effects, especially at higher frequencies, leading to increased resistive losses and thermal management challenges. These drawbacks motivate the exploration of alternative coil fabrication methods that offer improved performance, manufacturability, and integration with compact electronic form factors.

### SUMMARY

In some aspects, the subject disclosure relates to an apparatus comprising a first coil including a first plurality of turns of conductive traces and a second coil including a second plurality of turns of conductive traces and magnetically coupled to the first coil. At least one of the first coil or the second coil is fabricated by forming corresponding conductive traces on a substrate.

In some other aspects, the subject disclosure relates to a charging apparatus comprising a transmit (Tx) coil including a first plurality of turns of conductive traces, a receive (Rx) coil including a second plurality of turns of conductive traces, and a magnet configured to magnetically couple the Rx coil of a device to the Tx coil of a charger. At least one of the Tx coil or the Rx coil is fabricated by forming corresponding conductive traces on a substrate.

In yet other aspects, the subject disclosure relates to a method comprising obtaining a first substrate, forming a second substrate on the first substrate and forming a plurality of turns of windings of a coil on the second substrate using determined winding widths and spacings for different turns. The method further includes removing the second substrate in between and around the windings.

### BRIEF DESCRIPTION OF THE DRAWINGS

To easily identify the discussion of any particular element or act, the most significant digit or digits in a reference number refer to the figure number in which that element is first introduced.

FIGS. 1A, 1B and 1C are schematic diagrams illustrating various views of an example of a charging coil apparatus, according to some aspects of the subject technology.

FIG. 2 is a schematic diagram illustrating example designs of an enhanced charging coil device, according to some aspects of the subject technology.

FIG. 3 is a table illustrating parameters of an example of an enhanced charging coil, according to some aspects of the subject technology.

FIG. 4 is a flow diagram illustrating an example method of producing a charging coil, according to some aspects of the subject technology.

FIG. 5 is a schematic diagram illustrating an example of an AR device using the enhanced charging coil of the subject technology.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Some aspects of the subject disclosure are directed to an enhanced coil structure for wireless charging. Wireless charging systems consist of a charging pad connected to a power source, which contains a transmit coil, and a device that has a coil that receives power via mutual inductance between the transmit and receive coils. Wireless charging receiver coils, with a wire wound structure, are cost-effective at volumes of tens of millions per year in highly automated factories. For AR product volumes, wire coil production is less automated compared to the above scenario, and the cost can be reduced by using flexible printed-circuit (FPC) coils. For reasons that are self-evident, it is desired to maximize power transfer efficiency between the transmit and receive coils in the system. Furthermore, FPC coils can be designed with varying geometries that enables optimizing the wireless power transfer efficiency for a given product.

A transmit coil (e.g., under Qi2 standard) with a starship form-factor can be simulated, along with a receive coil, to calculate the maximum possible power transfer efficiency. First order analysis shows that minimizing receive coil resistance can maximize power transfer efficiency with all other parameters being fixed. It has been shown, however, that simply minimizing the receive coil resistance does not necessarily lead to maximum power transfer efficiency due to an anomalous trend seen in the coupled-coil performance.

For example, to achieve the highest possible power transfer efficiency, parametric studies can be conducted by varying the receive (Rx) coil geometry while coupled to the transmit (Tx) coil, in a form-factor simulation. These studies include an accurate depiction of the product geometry and material properties. The subject technology is based on an enhanced coil structure for wireless charging, where the design of the coil is enhanced using form-factor simulations while accounting for the anomalous trend in coupled-coil performance. The coil can be implemented in FPC or other technologies.

The anomalous resistance trend is studied using the simulation of Tx and Rx coils in the absence of surrounding metal. The simulation uses a constant current excitation for all parametric variations. Studying the resulting current density and electromagnetic (EM) loss in the Tx coil, it is observed that the current density increases when the Rx coil resistance is lower. The increased current density (with constant current excitation) results in higher I²*R losses and can be seen as a higher maximum transmit coil EM loss when coupled to the lower resistance Rx coil.

The subject technology optimizes the coil (e.g., Rx or Tx) by varying a number of parameters including, but not limited to, geometry (spiral, concentric circles, ellipses and the like), trace thickness, dielectric thickness, magnetic material properties, number of PC layers, inner trace width, outer trace width, inner coil radius, outer coil radius, inter-winding gap gradient polynomial coefficients and trace width gradient polynomial coefficients. Examples of parametric and fine tuning of coefficients and inner width along with examples of optimized coils with their corresponding parameters are provided herein.

The subject technology includes a number of advantageous features. For example, the disclosed solution by improving wireless charging coil efficiency directly impacts user experience. For instance, by allowing faster charging times and reduced thermal burden, the disclosed technology enables the ability to run the central processing unit (CPU) faster and the display faster and brighter. Furthermore, wireless radios can operate at higher power, which results in faster wireless throughput speeds and other benefits.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

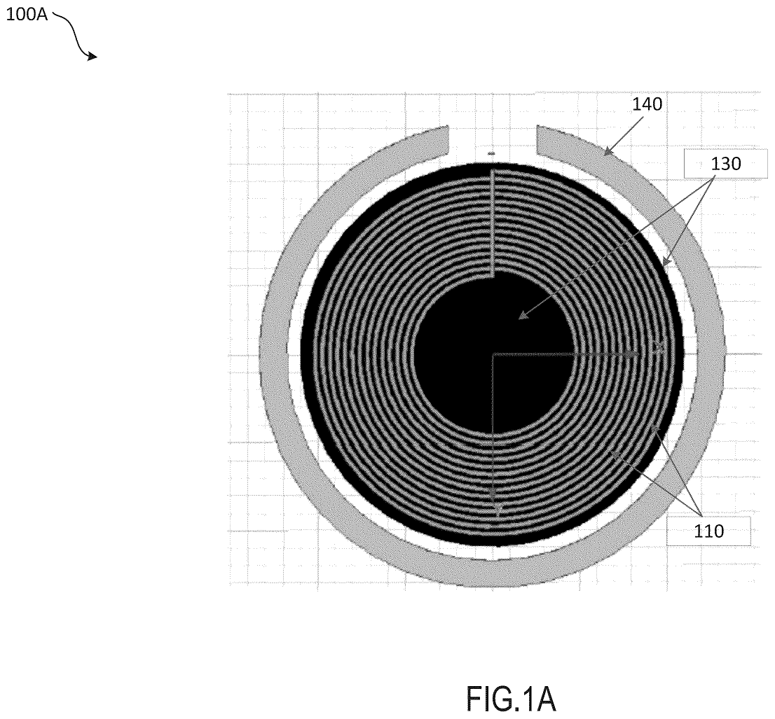

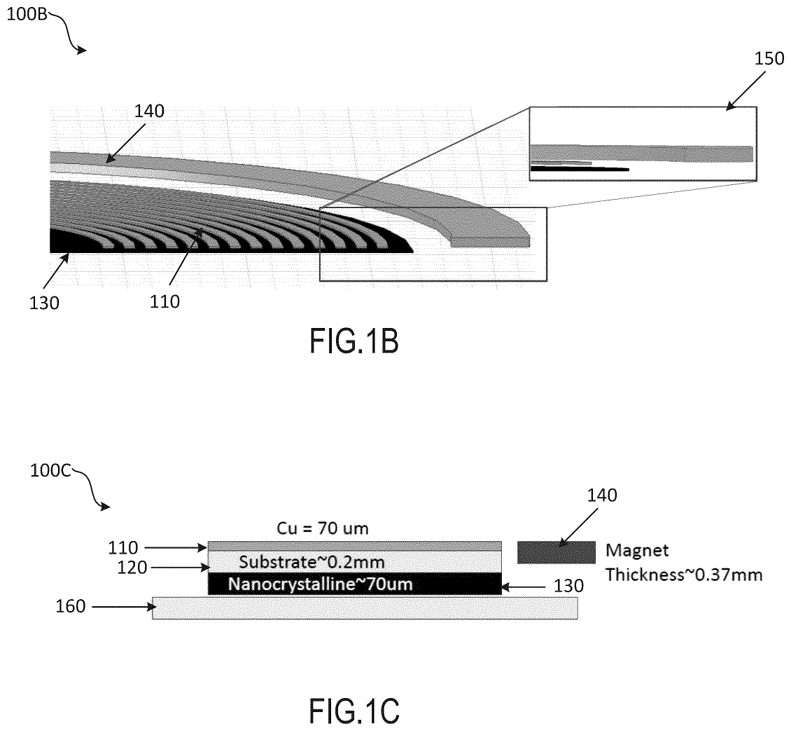

Turning now to the figures, FIGS. 1A, 1B and 1C are schematic diagrams illustrating various views 100A, 100B and 100C of an example of a charging coil apparatus, according to some aspects of the subject technology. The top view 100A shows a charging coil apparatus including a number of turns of winding (traces) of a coil 110, a base material 130 and a magnet 140. The coil 110 may be produced by forming traces of a conductive material (e.g., a metal such as copper or other metals) on the base material 130 using a photolithography process. In some implementations, the base material 130 includes, bit is not limited to, a nanocrystalline layer on which a substrate (e.g., a polymer-based material) is formed (not shown in FIG. 1A for simplicity). In some implementations, the base material 130 may be an FPC or other material. The conductive traces of the coil 110 are formed on the substrate (see 120 of FIG. 1C), the exposed portions of which not covered by the conductive traces are removed during the photolithography process and therefore are not visible in the top view 100A. In some implementations, the substrate includes, but is not limited to, a suitable material such as a polymer-based layer. The magnet 140 is made of a ferromagnetic material such as iron, nickel, cobalt, and certain alloys (e.g., alnico and neodymium).

In some implementations, the subject technology allows the conductive traces to be created with a desired width and/or spacing. This is a significant improvement over the existing coils, which use the same thickness wires with none or fixed spacing. The spacings and widths of different turns of the conductive traces of the coil 110 can vary with a radius of each turn. For example, the widths of the conductive tracings may increase/decrease as a function of radius of each turn. In some implementations, the spacings between the conductive tracings may increase/decrease as a function of radius of each turn. In some implementations, both the widths of and the conductive spacings between the conductive tracings may increase/decrease as a function of radius of each turn. The variation of the widths of and/or spacings between the conductive tracings may vary with the radius of each turn according to a desired linear or nonlinear function (e.g., a second order or higher order polynomial).

The top view 100B shows a perspective of a portion of the top view 100A along with an expanded window 150. The top view 100B indicates that the magnet 140 is thicker than the conductive traces of the coil 110 formed over the base material 130. Again, the substrate over which the conductive traces of the coil 110 are deposited are not visible in the top view 100B as it is hidden under the conductive traces of the coil 110.

The cross-section view 100C shows different layers of the charging coil apparatus. The layers include conductive traces of the coil 110 made for example of copper (Cu), the substrate layer 120, the base layer 130 (e.g., nanocrystalline layer of FPC) and a metal plate 160 of a case of the charging coil apparatus. The cross-section view 100C also shows the magnet 140 within the metal case. In some implementations, the thickness of the conductive traces of the coil 110 may be within a range of about 50 μm to 100 μm, for example, 70 μm. In some implementations, the thickness of the substrate 120 may be within a range of about 0.1 mm to 0.3 mm, for example, 0.2 mm. In some implementations, the thickness of the base material 130 may be within a range of about 50 μm to 100 μm, for example, 70 μm. In some implementations, the thickness of the magnet 140 may be within a range of about 0.2 mm to 0.5 mm, for example, 0.37 mm.

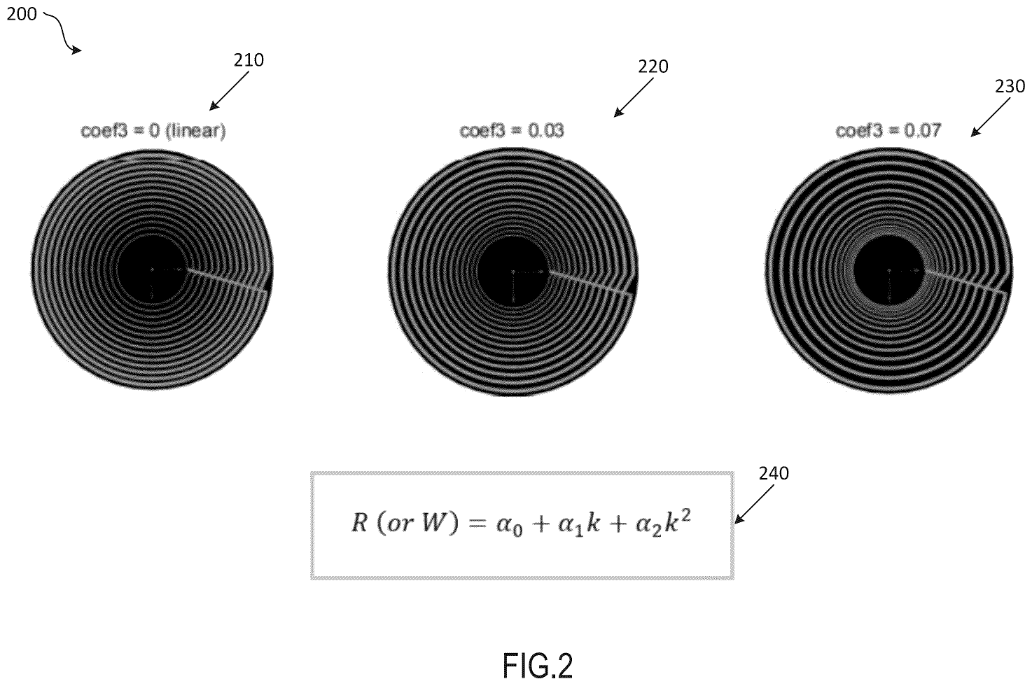

FIG. 2 is a schematic diagram illustrating example designs 200 of an enhanced charging coil device, according to some aspects of the subject technology. The designs 200 shown in FIG. 2 are, respectively, corresponding to charging coil devices 210, 220 and 230. The design of charging coil devices 210, 220 and 230 are generated by parameterizing the radius and width of every turn using the polynomial 240. In polynomial 240, R and W represent radius and width of traces of each turn and parameters α1, α2 and α3 are coefficients that control the radius (R) or width (W) of each turn. The parameter k is a constant that is proportional to the turn (winding) number of the traces. For example, for charging coil device 210, quadratic term (parameter «3) is zero such that the polynomial 240 becomes a linear function. The quadratic term for charging coil devices 220 and 230 is 0.03 and 0.07, respectively, corresponding to nonlinear polynomial functions. In some implementations, when n is a turn number, the parameter k can be, but is not limited to, (n−1).

In some embodiments, the interspacing of turns of the charging coil may also be characterized by a polynomial similar to the polynomial 240. Polynomial 240 is in fact a model that can be a basis for simulation of a charging coil design, that allows analyzing a specific design in terms of efficiency. The efficiency in the context of the current disclosure refers to the power transfer efficiency between the Tx coil of a wireless charger and an Rx coil of an electronic device being charged (e.g., a cell phone, an MR, an AR, a VR, a wrist band or any other electronic device).

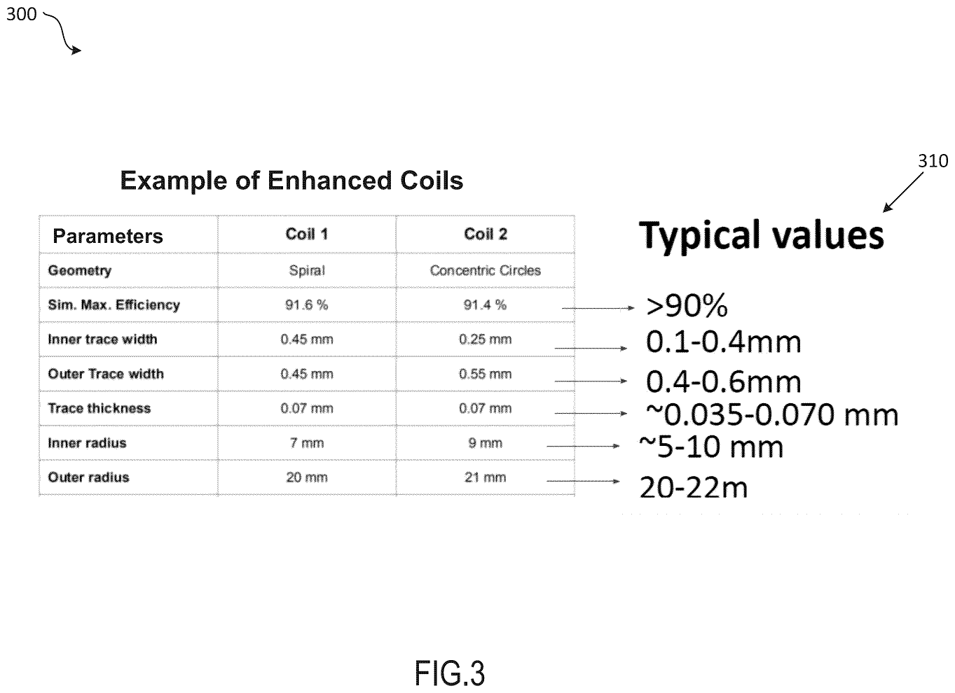

FIG. 3 is a table 300 illustrating parameters of an example of an enhanced charging coil, according to some aspects of the subject technology. In table 300, the parameters column includes geometry, simulated highest efficiency, inter-trace width, outer trace width, trace thickness, inner radius, and outer radius. Columns entitled Coil 1 and Coil 2 include values of the parameters for two exemplary charging coils. Typical values of the parameters of an exemplary charging coil of the subject technology are shown in column 310, indicating that for the range of parameters shown in column 310, the efficiency can be higher than about 90%, which significantly exceeds efficiency of existing wired windings. Moreover, the flexibility of designing by varying parameters discussed above is not available in existing wired windings. For example, for the existing wire windings, only the number of turns and the thickness of the wire (e.g., copper) can be varied, whereas using the subject technique, all parameters shown in table 300 can be varied to achieve a desired design with the highest efficiency.

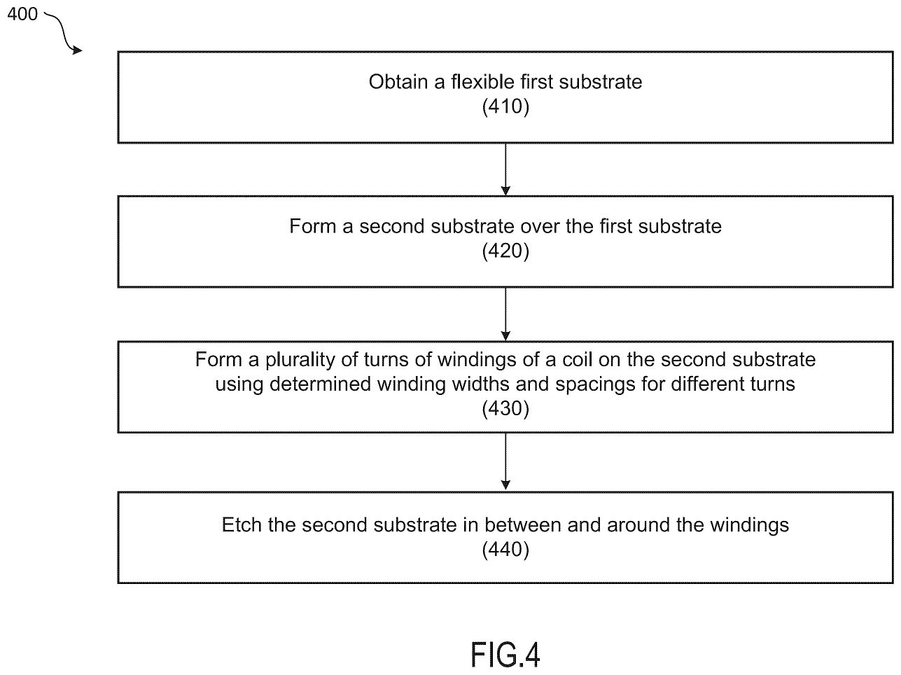

FIG. 4 is a flow diagram illustrating an example method 400 of producing a charging coil, according to some aspects of the subject technology. The method 400 includes process steps 410, 420, 430 and 440 producing a charging coil of the subject technology (e.g., as shown in 100A of FIG. 1A).

In process step 410, a first substrate (e.g., basis material 130 of FIG. 1C), for example, a flexible substrate, is obtained and used. In some implementations, the first substrate is a PC or an FPC. In some implementations, the first substrate is a nanocrystalline layer.

In process step 420, a second substrate (e.g., substrate 120 of FIG. 1C) is formed over the first substrate. In some implementations, the second substrate is a polymer.

In process step 430, a number of turns of windings (traces such as 110 of FIG. 1A) of a charging coil is formed using a deposition technique, for example, but not limited to, electroplating or chemical vapor deposition (CVD) on the second substrate using winding widths (or radius) and spacings for different turns. The winding widths (W) or radius (R) are determined using a design simulation based on the polynomial 240 of FIG. 2.

In process step 440, the second substrate is etched away in between and around the windings. As a result, the second substrate is present under the traces of the coil 110 but not visible in the top view 100A of FIG. 1A.

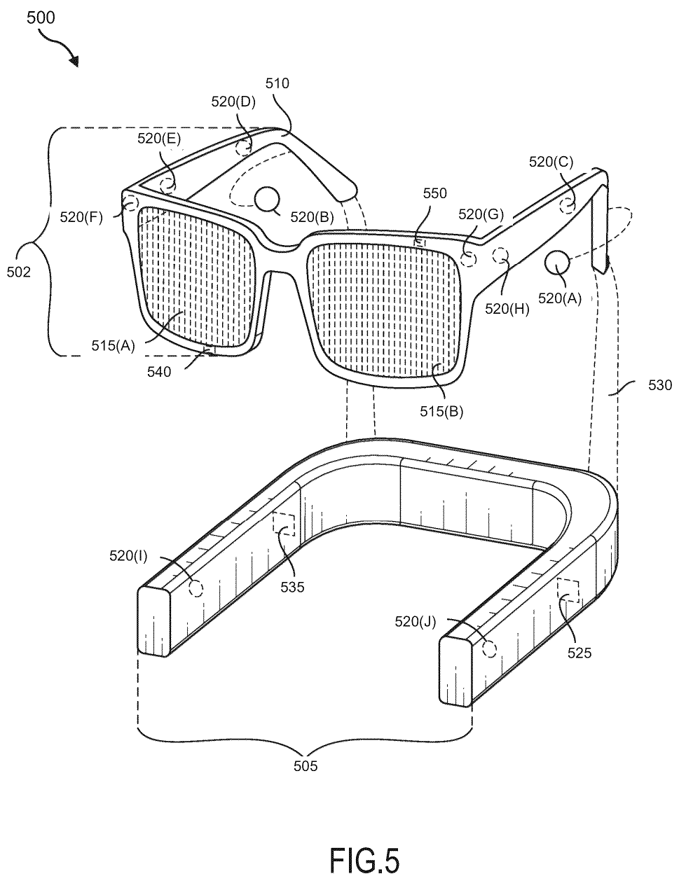

FIG. 5 is a schematic diagram illustrating an example of an AR device 500 using the enhanced charging coil of the subject technology. AR device 500 may include an eyewear device 502 with a frame 510 configured to hold a left display device 515(A) and a right display device 515(B) in front of a user's eyes. Display devices 515(A) and 515(B) may act together or independently to present an image or series of images to a user. While AR device 500 includes two displays, embodiments of this disclosure may be implemented in AR devices with a single near-eye device (NED) or more than two NEDs.

In some embodiments, AR device 500 may include one or more sensors, such as sensor 540. Sensor 540 may generate measurement signals in response to motion of AR device 500 and may be located on substantially any portion of frame 510. Sensor 540 may represent one or more of a variety of different sensing mechanisms, such as a position sensor, an inertial measurement unit (IMU), a depth camera assembly, a structured light emitter and/or detector, or any combination thereof. In some embodiments, AR device 500 may or may not include sensor 540 or may include more than one sensor. In embodiments in which sensor 540 includes an IMU, the IMU may generate calibration data based on measurement signals from sensor 540. Examples of sensor 540 may include, without limitation, accelerometers, gyroscopes, magnetometers, other suitable types of sensors that detect motion, sensors used for error correction of the IMU, or some combination thereof.

In some examples, AR device 500 may also include a microphone array with a plurality of acoustic transducers 520(A)-520(J), referred to collectively as acoustic transducers 520. Acoustic transducers 520 may represent transducers that detect air pressure variations induced by sound waves. Each acoustic transducer 520 may be configured to detect sound and convert the detected sound into an electronic format (e.g., an analog or digital format). The microphone array in FIG. 5 may include, for example, ten acoustic transducers: 520(A) and 520(B), which may be designed to be placed inside a corresponding ear of the user, acoustic transducers 520(C), 520(D), 520(E), 520(F), 520(G), and 520(H), which may be positioned at various locations on frame 510, and/or acoustic transducers 520(I) and 520(J), which may be positioned on a corresponding neckband 505.

In some embodiments, one or more of acoustic transducers 520(A)-(J) may be used as output transducers (e.g., speakers). For example, acoustic transducers 520(A) and/or 520(B) may be earbuds or any other suitable type of headphone or speaker.

The configuration of acoustic transducers 520 of the microphone array may vary. While AR device 500 is shown in FIG. 5 as having ten acoustic transducers 520, the number of acoustic transducers 520 may be greater or less than ten. In some embodiments, using higher numbers of acoustic transducers 520 may increase the amount of audio information collected and/or the sensitivity and accuracy of the audio information. In contrast, using a lower number of acoustic transducers 520 may decrease the computing power required by an associated controller 550 to process the collected audio information. In addition, the position of each acoustic transducer 520 of the microphone array may vary. For example, the position of an acoustic transducer 520 may include a defined position on the user, a defined coordinate on frame 510, an orientation associated with each acoustic transducer 520, or some combination thereof.

Acoustic transducers 520(A) and 520(B) may be positioned on different parts of the user's ear, such as behind the pinna, behind the tragus, and/or within the auricle or fossa. Or, there may be additional acoustic transducers 520 on or surrounding the ear in addition to acoustic transducers 520 inside the ear canal. Having an acoustic transducer 520 positioned next to an ear canal of a user may enable the microphone array to collect information on how sounds arrive at the ear canal. By positioning at least two of acoustic transducers 520 on either side of a user's head (e.g., as binaural microphones), augmented-reality device 500 may simulate binaural hearing and capture a 3D stereo sound field around a user's head. In some embodiments, acoustic transducers 520(A) and 520(B) may be connected to AR device 500 via a wired connection 530, and in other embodiments acoustic transducers 520(A) and 520(B) may be connected to AR device 500 via a wireless connection (e.g., a BLUETOOTH connection). In still other embodiments, acoustic transducers 520(A) and 520(B) may not be used at all in conjunction with AR device 500.

Acoustic transducers 520 on frame 510 may be positioned in a variety of different ways, including along the length of the temples, across the bridge, above or below display devices 515(A) and 515(B), or some combination thereof. Acoustic transducers 520 may also be oriented such that the microphone array is able to detect sounds in a wide range of directions surrounding the user wearing the AR device 500. In some embodiments, an optimization process may be performed during manufacturing of AR device 500 to determine relative positioning of each acoustic transducer 520 in the microphone array.

In some examples, AR device 500 may include or be connected to an external device (e.g., a paired device), such as neckband 505. Neckband 505 generally represents any type or form of paired device. Thus, the following discussion of neckband 505 may also apply to various other paired devices, such as charging cases, smart watches, smart phones, wrist bands, other wearable devices, hand-held controllers, tablet computers, laptop computers, other external compute devices, etc.

As shown, neckband 505 may be coupled to eyewear device 502 via one or more connectors. The connectors may be wired or wireless and may include electrical and/or non-electrical (e.g., structural) components. In some cases, eyewear device 502 and neckband 505 may operate independently without any wired or wireless connection between them. While FIG. 5 illustrates the components of eyewear device 502 and neckband 505 in example locations on eyewear device 502 and neckband 505, the components may be located elsewhere and/or distributed differently on eyewear device 502 and/or neckband 505. In some embodiments, the components of eyewear device 502 and neckband 505 may be located on one or more additional peripheral devices paired with eyewear device 502, neckband 505, or some combination thereof.

Pairing external devices, such as neckband 505, with augmented-reality eyewear devices may enable the eyewear devices to achieve the form factor of a pair of glasses while still providing sufficient battery and computation power for expanded capabilities. Some or all of the battery power, computational resources, and/or additional features of AR device 500 may be provided by a paired device or shared between a paired device and an eyewear device, thus reducing the weight, heat profile, and form factor of the eyewear device overall while still retaining desired functionality. For example, neckband 505 may allow components that would otherwise be included on an eyewear device to be included in neckband 505 since users may tolerate a heavier weight load on their shoulders than they would tolerate on their heads. Neckband 505 may also have a larger surface area over which to diffuse and disperse heat to the ambient environment. Thus, neckband 505 may allow for greater battery and computation capacity than might otherwise have been possible on a stand-alone eyewear device. Since weight carried in neckband 505 may be less invasive to a user than weight carried in eyewear device 502, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 505 may be communicatively coupled with eyewear device 502 and/or to other devices. These other devices may provide certain functions (e.g., tracking, localizing, depth mapping, processing, storage, etc.) to AR device 500. In the embodiment of FIG. 5, neckband 505 may include two acoustic transducers (e.g., 520(I) and 520(J)) that are part of the microphone array (or potentially form their own microphone subarray). Neckband 505 may also include a controller 525 and a power source 535.

Acoustic transducers 520(I) and 520(J) of neckband 505 may be configured to detect sound and convert the detected sound into an electronic format (analog or digital). In the embodiment of FIG. 5, acoustic transducers 520(I) and 520(J) may be positioned on neckband 505, thereby increasing the distance between the neckband acoustic transducers 520(I) and 520(J) and other acoustic transducers 520 positioned on eyewear device 502. In some cases, increasing the distance between acoustic transducers 520 of the microphone array may improve the accuracy of beamforming performed via the microphone array. For example, if a sound is detected by acoustic transducers 520(C) and 520(D) and the distance between acoustic transducers 520(C) and 520(D) is greater than, e.g., the distance between acoustic transducers 520(D) and 520(E), the determined source location of the detected sound may be more accurate than if the sound had been detected by acoustic transducers 520(D) and 520(E).

Controller 525 of neckband 505 may process information generated by the sensors on neckband 505 and/or AR device 500. For example, controller 525 may process information from the microphone array that describes sounds detected by the microphone array. For each detected sound, controller 525 may perform a direction-of-arrival (DOA) estimation to estimate a direction from which the detected sound arrived at the microphone array. As the microphone array detects sounds, controller 525 may populate an audio data set with the information. In embodiments in which AR device 500 includes an inertial measurement unit, controller 525 may compute all inertial and spatial calculations from the IMU located on eyewear device 502. A connector may convey information between AR device 500 and neckband 505 and between AR device 500 and controller 525. The information may be in the form of optical data, electrical data, wireless data, or any other transmittable data form. Moving the processing of information generated by AR device 500 to neckband 505 may reduce weight and heat in eyewear device 502, making it more comfortable to the user.

Power source 535 in neckband 505 may provide power to eyewear device 502 and/or to neckband 505. Power source 535 may include, without limitation, lithium ion batteries, lithium-polymer batteries, primary lithium batteries, alkaline batteries, or any other form of power storage. In some cases, power source 535 may be a wired power source. Including power source 535 on neckband 505 instead of on eyewear device 502 may help better distribute the weight and heat generated by power source 535. In some implementations, the power source 535 may use the enhanced charging coil of the subject technology (e.g., as shown in 100A of FIG. 1A) to wirelessly charge one or more rechargeable batteries of the eyewear device 502.

An aspect of the subject technology is directed to an apparatus comprising a first coil including a first plurality of turns of conductive traces and a second coil including a second plurality of turns of conductive traces and magnetically coupled to the first coil. At least one of the first coil or the second coil is fabricated by forming corresponding conductive traces on a substrate.

In some implementations, an inter-trace spacing between two traces of the corresponding conductive traces is configurable and determined based on an average distance of the two traces from a coil center, wherein the coil center is a center of the first coil and the second coil.

In one or more implementations, a width of a trace of the corresponding conductive traces is configurable and determined based on a distance of the trace from the coil center.

In some implementations, the conductive traces are made of a conductive material wherein the conductive material comprises a metal including copper.

In one or more implementations, a substrate comprises an FPC.

In some implementations, the substrate comprises a polymer-based layer formed on a base layer including nanocrystalline material.

In one or more implementations, a radius of each trace of the corresponding conductive traces is a polynomial function of a turn number of that trace.

In some implementations, at least one of the first coil or the second coil comprises an enhanced coil designed to provide a highest power transfer efficiency, wherein the highest power transfer efficiency is more than 90 percent.

Another aspect of the subject technology is directed to a charging apparatus, comprising a transmit (Tx) coil including a first plurality of turns of conductive traces, a receive (Rx) coil including a second plurality of turns of conductive traces, and a magnet configured to magnetically couple the Rx coil of a device to the Tx coil of a charger. At least one of the Tx coil or the Rx coil is fabricated by forming corresponding conductive traces on a substrate.

In some implementations, the conductive traces are made of a conductive material wherein the conductive material comprises a metal including copper.

In one or more implementations, an inter-trace spacing between two traces of the corresponding conductive traces is configurable and determined based on an average distance of the two traces from a coil center, wherein the coil center is a center of the Tx coil and the Rx coil.

In some implementations, a width of a trace of the corresponding conductive traces is configurable and determined based on a distance of the trace from the coil center.

In one or more implementations, the substrate comprises a polymer-based layer formed on a base layer including nanocrystalline material.

In some implementations, a radius of each trace of the corresponding conductive traces is a polynomial function of a turn number of that trace.

In one or more implementations, at least one of the Rx coil or the Tx coil comprises an enhanced coil designed to provide a highest power transfer efficiency, wherein the highest power transfer efficiency is more than about 90 percent.

Yet another aspect of the subject technology is directed to a method comprising obtaining a first substrate, forming a second substrate on the first substrate and forming a plurality of turns of windings of a coil on the second substrate using determined winding widths and spacings for different turns. The method further includes removing the second substrate in between and around the windings.

In one or more implementations, the first substrate comprises a nanocrystalline material layer, wherein the second substrate comprises a polymer-based material.

In some implementations, the method further comprises forming the plurality of turns of windings of the coil using conductive traces made of a conductive material, wherein the conductive material comprises a metal including copper.

In one or more implementations, the method further comprises determining a winding width associated with each turn of the plurality of turns of windings based on a polynomial function.

In some implementations, the method further comprises determining inter-spacing associated with each turn of the plurality of turns of windings based on a polynomial function.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An apparatus, comprising:
a first coil including a first plurality of turns of conductive traces; and
a second coil including a second plurality of turns of conductive traces and magnetically coupled to the first coil,
wherein,
at least one of the first coil or the second coil is fabricated by forming corresponding conductive traces on a substrate.

2. The apparatus of claim 1, wherein an inter-trace spacing between two traces of the corresponding conductive traces is configurable and determined based on an average distance of the two traces from a coil center, wherein the coil center is a center of the first coil and the second coil.

3. The apparatus of claim 2, wherein a width of a trace of the corresponding conductive traces is configurable and determined based on a distance of the trace from the coil center.

4. The apparatus of claim 1, wherein the conductive traces are made of a conductive material wherein the conductive material comprises a metal including copper.

5. The apparatus of claim 1, wherein the substrate comprises a flexible printed circuit (FPC).

6. The apparatus of claim 1, wherein the substrate comprises a polymer-based layer formed on a base layer including nanocrystalline material.

7. The apparatus of claim 1, wherein a radius of each trace of the corresponding conductive traces is a polynomial function of a turn number of that trace.

8. The apparatus of claim 4, wherein at least one of the first coil or the second coil comprises an enhanced coil designed to provide a highest power transfer efficiency, wherein the highest power transfer efficiency is more than 90 percent.

9. A charging apparatus, comprising:
a transmit (Tx) coil including a first plurality of turns of conductive traces;
a receive (Rx) coil including a second plurality of turns of conductive traces; and
a magnet configured to magnetically couple the Rx coil of a device to the Tx coil of a charger,
wherein,
at least one of the Tx coil or the Rx coil is fabricated by forming corresponding conductive traces on a substrate.

10. The charging apparatus of claim 9, wherein the conductive traces are made of a conductive material wherein the conductive material comprises a metal including copper.

11. The charging apparatus of claim 9, wherein an inter-trace spacing between two traces of the corresponding conductive traces is configurable and determined based on an average distance of the two traces from a coil center, wherein the coil center is a center of the Tx coil and the Rx coil.

12. The charging apparatus of claim 11, wherein a width of a trace of the corresponding conductive traces is configurable and determined based on a distance of the trace from the coil center.

13. The charging apparatus of claim 9, wherein the substrate comprises a polymer-based layer formed on a base layer including nanocrystalline material.

14. The charging apparatus of claim 9, wherein a radius of each trace of the corresponding conductive traces is a polynomial function of a turn number of that trace.

15. The charging apparatus of claim 9, wherein at least one of the Rx coil or the Tx coil comprises an enhanced coil designed to provide a highest power transfer efficiency, wherein the highest power transfer efficiency is more than about 90 percent.

16. A method, comprising:
obtaining a first substrate;
forming a second substrate on the first substrate;
forming a plurality of turns of windings of a coil on the second substrate using determined winding widths and spacings for different turns; and
removing the second substrate in between and around the windings.

17. The method of claim 16, wherein the first substrate comprises a nanocrystalline material layer, and wherein the second substrate comprises a polymer-based material.

18. The method of claim 16, further comprising forming the plurality of turns of windings of the coil using conductive traces made of a conductive material, wherein the conductive material comprises a metal including copper.

19. The method of claim 16, further comprising determining a winding width associated with each turn of the plurality of turns of windings based on a polynomial function.

20. The method of claim 16, further comprising determining inter-spacing associated with each turn of the plurality of turns of windings based on a polynomial function.
